(19) United States
(12) Patent Application Publication
(10) Pub. No.: US 2018/0070580 A1
(43) Pub. Date: Mar. 15, 2018

(54) ARTIFICIAL FOOD PILE

(71) Applicant: Anthony Laniewicz, Lawrenceville, GA (US)

(72) Inventor: Anthony Laniewicz, Lawrenceville, GA (US)

(21) Appl. No.: 15/703,935

(22) Filed: Sep. 13, 2017

Related U.S. Application Data
(60) Provisional application No. 62/394,184, filed on Sep. 13, 2016.

(51) Int. Cl. A01M 31/06

(52) U.S. Cl. CPC A01M 31/06

(57) ABSTRACT

Implementations of an artificial food pile are provided. In some implementations, the food pile comprises a first surface, a second surface on an opposing side to the first surface thereby forming a flat, round, two-side article having a predetermined thickness and predetermined diameter, and a cut extending through the article from an edge toward the center of the article thereby forming a first flap and a second flap. In some implementations, kernels of corn are printed on the first surface. To form a cone shape with the first surface facing up to resemble a corn pile, one of the flaps formed by the slit is pulled under the other flap. In some implementations, a reflective ring, design, or solid color may be printed on the second surface. In this way, when the second surface is facing up, the cone may be used as a signaling aide, a megaphone, a hat, or any other suitable use.

### CROSS REFERENCE TO RELATED APPLICATION

This application claims the benefit of U.S. Patent Application Ser. No. 62/394,184, which was filed on Sep. 13, 2017, and is incorporated herein by reference in its entirety.

### TECHNICAL FIELD

This disclosure relates to implementations of an artificial food pile.

### BACKGROUND

Hunters use attractants to lure wild game into the open. Existing attractants include real food piles such as piles of corn, apples, sugar beets, or pumpkins. However, using real food piles can be expensive and draw unwanted animals. Furthermore, real food piles can mold and become undesirable to wild game. Still further, real food piles are illegal in some states.

Existing artificial food piles such as the food piles disclosed in U.S. Pat. Nos. 2,730,828 and 4,607,447 are complex and do not serve multiple purposes.

### BRIEF DESCRIPTION OF THE DRAWINGS

FIG. 1 illustrates an implementation of a first side of an example article used to make an artificial food pile according to principles of the present disclosure.

FIG. 2 illustrates an implementation of a second side of an example article used to make an artificial food pile according to principles of the present disclosure.

FIGS. 3 and 4 illustrate an example method of using the articles of FIGS. 1 and 2 according to principles of the present disclosure.

### DETAILED DESCRIPTION

Implementations of an artificial food pile are provided. In some implementations, the food pile comprises a first surface, a second surface on an opposing side to the first surface thereby forming a flat, round, two-side article having a predetermined thickness and predetermined diameter, and a cut extending through the article from an edge toward the center of the article thereby forming a first flap and a second flap. In some implementations, kernels of corn are printed on the first surface. To form a cone shape with the first surface facing up to resemble a corn pile, one of the flaps formed by the slit is pulled under the other flap. In some implementations, a reflective ring, design, or solid color may be printed on the second surface. In this way, when the second surface is facing up, the cone may be used as a signaling aide, a megaphone, a hat, or any other suitable use.

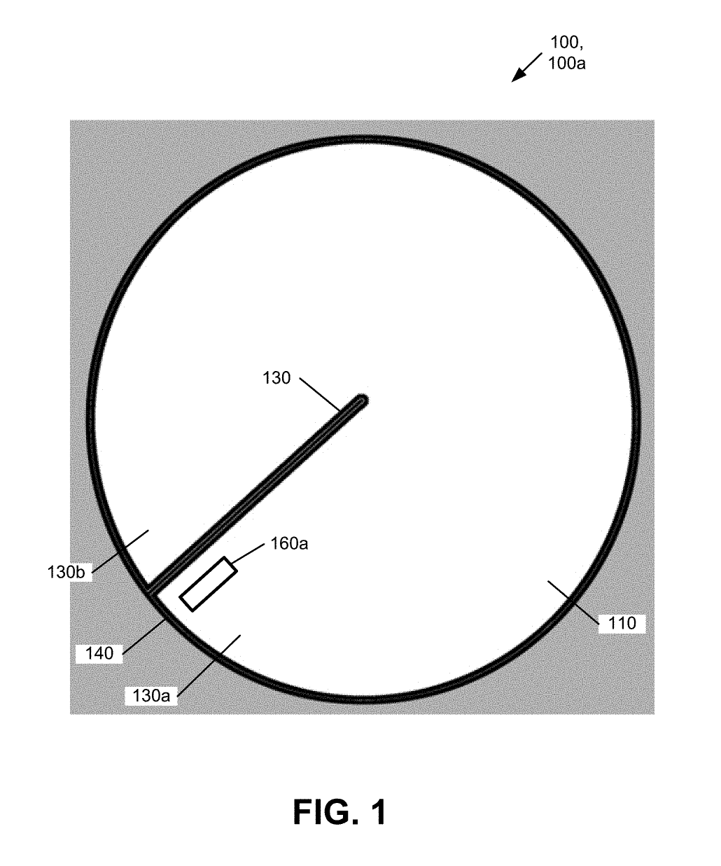

FIG. 1 illustrates an implementation of a first side 100a of an example article 100 used to make an artificial food pile according to principles of the present disclosure.

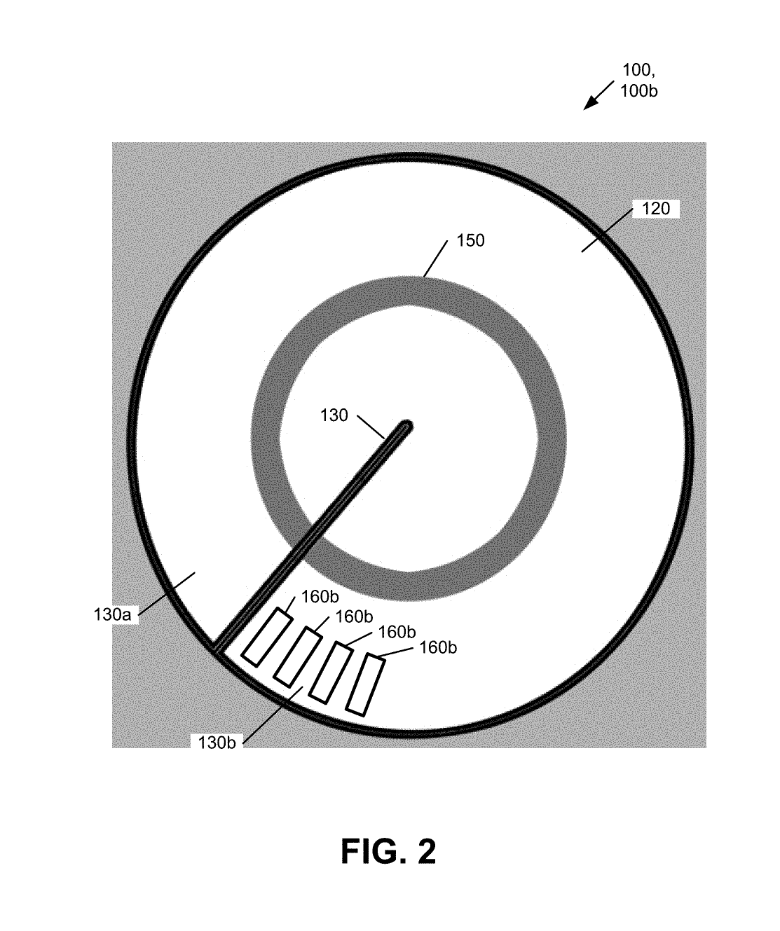

FIG. 2 illustrates an implementation of a second side 100b of an example article 100 used to make an artificial food pile according to principles of the present disclosure.

In some implementations, the article 100 has a first surface 110 and a second surface 120 on an opposing side to the first surface 110 thereby forming a two-sided article. In some implementations, the article 100 has a predetermined thickness. In some implementations, the first surface 110 and second surface 120 form a flat and round article 100 having a predetermined diameter. In some implementations, the article 100 is any other suitable shape.

In some implementations, the article 100 comprises a slit/cut 130 extending from its edge 140 toward the center of the material thereby forming a first flap 130a and a second flap 130b.

In some implementations, the article 100 is about 20 inches in diameter. In some implementations, the article 100 is about 28 inches in diameter. In some implementations, the article 100 is about 36 inches in diameter. In some implementations, the article 100 is less than 20 inches in diameter. In some implementations, the article 100 is between 20 and 28 inches in diameter. In some implementations, the article 100 is between 28 and 36 inches in diameter. In some implementations, the article 100 is greater than 36 inches in diameter.

In some implementations, the article 100 may be rubber or comprised of rubber. In some implementations, the article 100 may be neoprene or comprised of neoprene. In some implementations, the article 100 may be plastic or comprised of plastic. In some implementations, the article 100 may be vinyl or comprised of vinyl. In some implementations, the article 100 may be foam or comprised of foam. In some implementations, the article 100 may be close-cell foam or comprised of close-cell foam. In some implementations, the article 100 maybe be made from a rubbery, plastic material. In some implementations, the article 100 may be any suitable materiel or combination of material that is flexible enough to lay flat and be formed into a cone yet firm/rigid enough to maintain its cone shape (i.e., stand up).

In some implementations, the article 100 may have a food item printed on the first surface 110. In some implementations, the food item printed on the first surface 110 may be corn kernels. In this way, when in the cone shape (as discussed below), the article 100 may look like a pile of corn. In some implementations, the first surface 110 may have a texture (e.g., rough, bumpy, or dimpled) in conjunction with the picture of the corn to look more realistic. In some implementations, the first surface 110 may have any other food item (e.g., apples, etc.) printed thereon.

In some implementation, the article 100 may have a reflective ring 150 printed on the second surface 120. In this way, the article 100 can serve dual purposes. In some implementations, the reflective ring 150 may be centered about the article 100. In some implementations, the reflective ring 150 may not be centered about the article 100. In some implementations, the center of the reflective ring 150 may be centered about the center of the article 100. In some implementations, the center of the reflective ring 150 may not be centered about the center of the article 100.

In some implementation, the article 100 may have a solid color (e.g., orange) printed on the second surface 120. In this way, the article 100 can serve dual purposes. For example, when in the cone shape (as discussed below), the article 100 can be used to attract animals (e.g., when using the side having the food item printed thereon), or the article 100 can be used as a signaling aide, location marker, etc. (e.g., when using the side having the solid orange color printed thereon).

In some implementations, the article 100 may have any other suitable design, logo, or signage printed on the second surface 120. In this way, the article 100 can be used for multiple purposes when in the cone shape (discussed below) including an artificial food pile for attracting animals (such as deer), a hat, a safety cone, a signaling aide, a location marker, a megaphone, a basket, hat etc. The article can also be used as a mat.

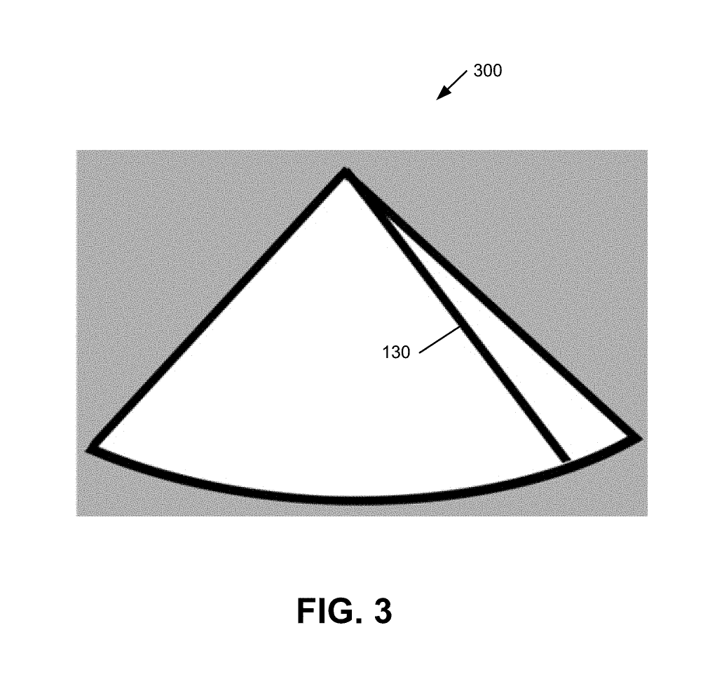

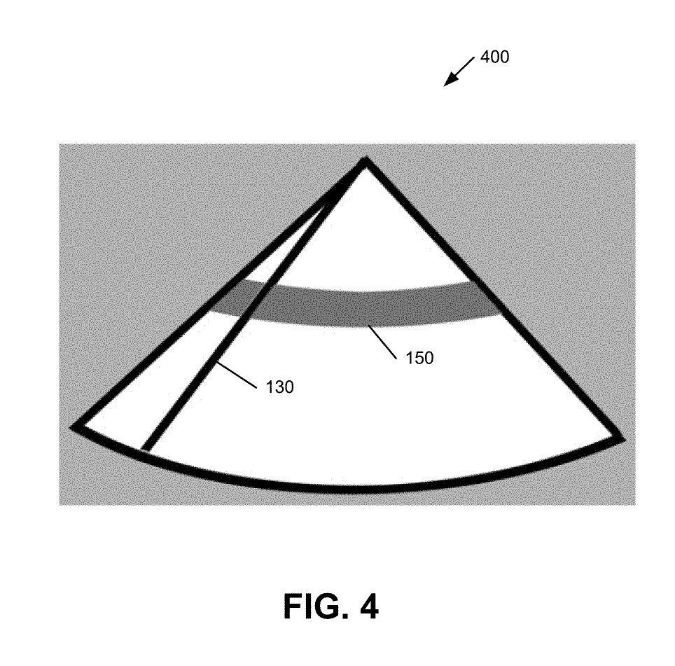

FIGS. 3 and 4 illustrate an example method of using the articles of FIGS. 1 and 2 according to principles of the present disclosure. In some implementations, the article may be converted into a cone shape 300, 400 to resemble a pile (or to be used as a signaling aide, megaphone, basket, hat, etc.) by pulling one of the flaps (e.g., 130a) formed by the slit under the other flap (e.g., 130b).

In some implementations, the flaps 130a, 130b may be secured to the article 100 so that the article 100 may maintain its cone shape. In some implementations, the flaps 130a, 130b may be secured using hook and loop fasteners. In some implementations, the flaps 130a, 130b may be secured using any suitable fasteners.

For example, in some implementations, the flaps 130a, 130b may include fasteners 160a, 160b, respectively, to secure the first flap 130 to the second flap 130. In some implementations, a fastener pair 160a, 160b may be snaps (e.g., the male 160a and female 160b portion of a snap); buttons (e.g., a button 160a and slit 1600b); magnets; hook (e.g., 160a) and loop (e.g., 160b) fasteners (e.g., Velcro®) or visa-versa; or other reclosable fasteners or fastening technology currently existing or developed in the future.

In some implementations, each flap may include one or more fastener parts to adjust the size of a cone. For example, as shown in FIGS. 1 and 2, the first flap 130a may include one fastener part 160a and the second flap 130b may include a plurality of fastener parts 160b to adjust the size of cone. In some implementations, the fastener parts 160b may extend around a portion of the material to adjust the size of a cone that may be constructed using the article 100. In some implementations, the plurality of fastener parts 160b extend around a portion of the article 100 near the article's 100 edge 140.

Fastener 160a may be on the side of the article 100 opposite the side of the article 100 that the fastener 160b is on for the fasteners to work properly. For example, fastener 160a may be on the first surface 110 of the article 100 and fastener 160b may be on the second surface 120 of the article 100 or vice-versa.

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. An article comprising:
a first surface;
a second surface on an opposing side to the first surface thereby forming a flat, round, two-side article having a predetermined thickness and predetermined diameter; and
a cut extending through the article from an edge toward the center of the article thereby forming a first flap and a second flap.

2. The article of claim 1 wherein the article is made from rubber.

3. The article of claim 1 wherein the article is made from neoprene.

4. The article of claim 1 wherein the article is made from plastic.

5. The article of claim 1 wherein the article is made from foam.

6. The article of claim 1 further comprising at least one fastener pair on the first flap and second flap configured to secure the first flap to the second flap.

7. The article of claim 6 wherein the fastener pair is a hook and loop fastener.

8. The article of claim 1 wherein the article comprises a food item printed on the first surface wherein the food item is kernels of corn.

9. The article of claim 8 wherein the article comprises a reflective ring printed on the second surface.

10. The article of claim 8 wherein the article comprises a design printed on the second surface.

11. An article comprising:
a first surface;
a second surface on an opposing side to the first surface thereby forming a flat, round, two-side article having a predetermined thickness and predetermined diameter;
a cut extending through the article from an edge toward the center of the article thereby forming a first flap and a second flap;
at least one fastener pair on the first flap and second flap configured to secure the first flap to the second flap; and
wherein the article comprises a food item printed on the first surface wherein the food item is kernels of corn and wherein the article comprises a reflective ring printed on the second surface.

12. A method of using the article of 1, the method comprising pulling one of the flaps formed by the slit under the other flap thereby forming a cone shape.

13. The method of claim 12 wherein the article further comprises a food item printed on the first surface wherein the food item is kernels of corn, the method further comprising facing the first surface up and using the cone as an animal attractant.

14. The method of claim 12 wherein the article further comprises a reflective ring printed on the second surface, the method further comprising facing the second surface up and using the cone as a signaling aide.

15. The method of claim 12 wherein the article further comprises a design printed on the second surface, the method further comprising facing the second surface up and using the cone as a megaphone.

16. The method of claim 12 wherein the article further comprises at least one fastener pair on the first flap and second flap configured to secure the first flap to the second flap, the method further comprising securing the first flap and the second to the article using the fastener pair.

17. A method of using the article of 1 wherein the article further comprises a food item printed on the first surface wherein the food item is kernels of corn; a reflective ring, design, or solid color printed on the second surface; at least one fastener pair on the first flap and second flap configured to secure the first flap to the second flap, the method comprising:
facing the first surface up, pulling one of the flaps formed by the slit under the other flap thereby forming a cone shape, and using the cone as an animal attractant;
facing the second surface up, pulling one of the flaps formed by the slit under the other flap thereby forming a cone shape, and using the cone as a signaling aide, a megaphone, or a hat; and
securing the first flap and the second to the article using the at least one fastener pair.
